(19) United States
(12) Patent Application Publication
(10) Pub. No.: US 2025/0330800 A1
(43) Pub. Date: Oct. 23, 2025

(54) OPERATIONAL SUBSCRIPTION PROFILE DOWNLOAD

(71) Applicant: Telefonaktiebolaget LM Ericsson (publ), Stockholm (SE)

(72) Inventors: Per STÅHL, Klagshamn (SE); Juha SÄÄSKILAHTI, Espoo (FI)

(73) Assignee: Telefonaktiebolaget LM Ericsson (publ), Stockholm (SE)

(21) Appl. No.: 18/864,308

(22) PCT Filed: Sep. 22, 2022
(86) PCT No.: PCT/SE2022/050838

§ 371 Date: Nov. 8, 2024

Related U.S. Application Data
(60) Provisional application No. 63/341,100, filed on May 12, 2022.

(51) Int. Cl. H04W 8/20; H04W 12/0431; H04W 12/06; H04W 76/10

(52) U.S. Cl. CPC H04W 8/20; H04W 12/0431; H04W 12/06; H04W 76/10

(57) ABSTRACT

A method for operational subscription profile download and installation, the method being performed by a subscriber module (1200) in a communication device (180). The method comprises: obtaining (S102) download information for the operational subscription profile from an eSIM server (1400) and over an initial cellular connectivity connection for the communication device, wherein during cellular network access authentication to establish the initial cellular connectivity connection the subscriber module authenticates the eSIM server using the subscription data; downloading (S104) the operational subscription profile from an enhanced Subscription Manager Data Preparation entity (150) and in accordance with the download information, wherein the operational sub-scription profile is downloaded over the initial cellular connectivity connection for the communication device; and installing (S106) the operational subscription profile in the subscriber module. A communication device, eSIM servers, subscription modules, computer programs, a computer program product and further method are also disclosed.

### TECHNICAL FIELD

The invention presented herein relate to a method, subscriber modules, a communication device, a computer program, and a computer program product for operational subscription profile download and installation. The invention further relate to a method, embedded Subscriber Identity Module (eSIM) servers, a computer program, and a computer program product for enabling operational subscription profile download and installation to the subscriber module.

### BACKGROUND

The Global System for Mobile communication Alliance (GSMA) has specified how to provide subscribers with third generation partnership project (3GPP) subscription profiles, often denoted Subscriber Identity Module (SIM) subscription profiles, hereinafter denoted subscription profiles. Such subscription profiles can be remotely downloaded over the Internet to the physical hardware in the communication device known as embedded UICC/embedded Universal Integrated Circuit Card (eUICC) or integrated UICC/Universal Integrated Circuit Card (iUICC) or integrated embedded UICC/Universal Integrated Circuit Card (ieUICC). A remote SIM provisioning protocol (RSP) is followed to remotely deliver subscription profiles from a provisioning server (such as an enhanced Subscription Manager Data Preparation (SM-DP+) server; hereinafter denoted SM-DP+ entity for short) to the communication device. Remote SIM provisioning for consumer devices is described in the documents “SGP.21-RSP Architecture Specification v2.4” and “SGP.22-RSP Technical Specification v2.4”.

A communication device downloads the subscription profile from the SM-DP+ entity. When a mobile network operator (MNO) orders a subscription profile from the SM-DP+ entity, the SM-DP+ entity will prepare a subscription profile that will be available for download for the communication device. During the subscription profile ordering phase the MNO also performs necessary network provisioning actions. In particular, to gain initial cellular-based connectivity when the communication device starts up for the first time, a suitable SIM subscription profile that works where the communication device is located needs to be installed into the communication device at manufacturing. Such a SIM subscription profile is hereinafter referred to as a bootstrap subscription profile or provisioning subscription profile. It is often not known where a particular communication device will end up when the eUICC/module/device is manufactured. For this reason, a provisioning subscription profile of an MNO with global roaming agreements is desired.

In general terms, eSIM services for communication devices in the form of Internet of Things (IoT) devices are available where, based on geographical location of the IoT device, knowledge of pre-negotiated agreements with MNOs, IoT device information, etc., is used as input to a localization procedure performed to determine the proper MNO, provisioning server, and subscription profile to be used for a particular IoT device. Download of the operational subscription profile is then triggered. Such eSIM services might be provided by an eSIM server and might, for example, be triggered as the IoT device boots up for the first time.

Since an IoT device is typically without user interface, IoT devices might not be able to establish user consent for operations pertaining to subscription profiles. In the considered provisioning techniques for IoT devices, the IoT device is configured to accept subscription profile download triggering operations and subscription profile management operations (such as enable, disable, and delete of subscription profiles) sent to the IoT device over an established secure communication channel from an authorized (remote) server, hereinafter denoted a managing entity, without seeking any user confirmation via some local or remote user interface. This allows automated subscription profile handling of a batch, say hundreds or thousands, of IoT devices. The managing entity might be referred to as an eSIM IoT remote Manager (eIM). According to the document “SGP.31—eSIM IoT Architecture and Requirements v1.0” as published by GSMA, the intent is that the IoT eSIM variant can utilize the existing SM-DP+ and Subscription Manager Discovery Service (SM-DS) infrastructure based on the eSIM consumer variant as is. Hence, the IoT eSIM variant supports the same three methods (as summarized below) as in the eSIM consumer variant to provide information to the communication device that a subscription profile is pending for download. For secure subscription profile management in IoT devices, secure communication must be established between the IoT device and the managing entity which relies on key material being available at the IoT device and the managing entity. For example, a pre-shared key may be used or private-public key pairs and certificates for the two entities are used. In the GSMA eSIM IoT Architecture (SGP.31) the secure communication channel between the IoT device and device management server acting as managing entity may be leveraged for securing the triggering of subscription profile download and subscription profile management operations. Establishing the key material at both parties is out of scope of the GSMA proposed solution. It may for example rely on the bootstrap process of the IoT devices to setup the key material. The GSMA eSIM IoT Architecture for low-power IoT devices addresses memory and/or power constrained IoT devices and IoT devices connecting over low-power wide-area (LPWA) networks. Such devices typically cannot support Hypertext Transfer Protocol Secure (HTTPS) communication with the SM-DP+ entity as required by SGP.22. For these devices the subscription profile download (and notification handling) is performed via the managing entity to the SM-DP+ entity leveraging the secure communication between the IoT device and the managing entity, and the managing entity handles the HTTPS communication with the SM-DP+ entity.

There are currently three options, below denoted option 1, option 2, and option 3, defined to provide information to the communication device that a subscription profile is pending for download.

Option 1: At the subscription profile ordering phase, either the MNO receives (over an ES2+ interface) an Activation Code (AC) from the SM-DP+, or the MNO generates an AC from data received from the SM-DP+. The MNO then hands out to the AC to the customer, e.g., in a form of a Quick Response (QR) code that can be read by the communication device and used by the communication device to contact the SM-DP+. The customer triggers download of the subscription profile by providing the AC to the communication device that then, based on information from the AC, is enabled to connect to the proper SM-DP+ to download the subscription profile.

Option 2: The communication device is configured with, or at least has access to, a default SM-DP+ address that defines the SM-DP+ to use for download of the subscription profile. For example, at first power-up during commissioning of the communication device, or based some other defined trigger, the communication device connects to the default SM-DP+ to download the subscription profile.

Option 3: At the subscription profile ordering phase, the MNO requests the SM-DP+ to register information about an available subscription profile for a particular communication device at a discovery service (such as an SM-DS). An event is then created at the SM-DS for the particular communication device, instructing the communication device to connect to the SM-DP+ to download the subscription profile. The communication device is configured to contact the SM-DS, for example, at first power-up during commissioning of the communication device, to check for pending subscription profile download events. Upon successful download of the event from the SM-DS, the communication device connects to the SM-DP+ given by the event to download the subscription profile. GSMA has currently specified a root SM-DS, which is common for all communication devices. There may, however, be subsidiary SM-DS servers, and vendor specific discovery services, and thus diverse SM-DS servers.

According to option 2 and option 3 the MNO provides the eUICC identifier (EID) of the communication device and the prepared subscription profile package for download is bound to the EID in the SM-DP+. According to option 1 there is no need for the MNO (or SM-DP+) to know the EID at the time of subscription profile ordering. In option 1, the communication device receives, via the AC, a Matching ID (MID) that the communication device presents to the SM-DP+ during download of the subscription profile to identify the correct prepared subscription profile package.

In the GSMA eSIM IoT Architecture as specified in the aforementioned document “SGP.31—eSIM IoT Architecture and Requirements v1.0” an extra layer of protection is added between the managing entity and the subscriber module, in addition to the secure channel between the communication device and the managing entity, in order to protect against potential malwares residing in the communication devices. According to the architecture, the managing entity must sign using its private key all commands/operations to the subscriber module that relates to subscription profile state management operations and the subscriber module must verify the signature, using the managing entity public key that has been securely configured in the subscriber module, before accepting the subscription profile state management operations (PSMOs) such as subscription profile enable, subscription profile disable, and subscription profile delete. This is to ensure that a malware cannot (download, install, and) enable a rogue subscription profile into the subscriber module or that the malware cannot disable or delete already installed subscription profiles resulting in loss of connectivity and need for re-installation of subscription profiles. The signed PSMOs protects the management operation, data that uniquely identifies the subscription profile (e.g., Integrated Circuit Card ID; ICCID), and data (e.g., counter or random) for replay protection.

The configuration of the managing entity public key into the subscriber module may be performed at different stages such as subscriber module production, communication device production, and in-field when the communication device is brought into use. Currently, subscription profile state management is only possible when a managing entity public key has been configured into the subscriber module. In addition, automatic enabling of a subscription profile is allowed without a signed PSMO in case of subscription profile download from default SM-DP+ entity (as in option 2) or from the SM-DP+ entity obtained via the SM-DS entity (as in option 3).

Although the GSMA eSIM IoT Architecture prevents malwares in a communication device from modifying the state of subscription profiles, it does not prevent a malware from orchestrating download and installation of a new subscription profile. The architecture further does not prevent a person knowing the EID of a particular communication device to order an unwanted subscription profile for that particular communication device and have it prepared for download e.g., via an SM-DP+ entity whose information is obtained via the same SM-DS entity as the communication device uses to check for subscription profiles to download.

### SUMMARY

An object of embodiments herein is to address at least one of the above issues and/or to enable a security improvement in the handling of an operational subscription profile.

According to a first aspect there is presented a method for operational subscription profile download and installation. The method is performed by a subscriber module. The subscriber module is provided in a communication device. The subscriber module is provided with subscription data for use in establishing initial cellular connectivity. The method comprises obtaining download information for the operational subscription profile from an eSIM server and over an initial cellular connectivity connection for the communication device. The download information is used by the subscriber module when determining that subscription profile download is authorized for the subscriber module. The subscriber module authenticates the eSIM server using the subscription data during cellular network access authentication to establish the initial cellular connectivity connection. The method comprises downloading the operational subscription profile from an SM-DP+ entity and in accordance with the download information. The operational subscription profile is downloaded over the initial cellular connectivity connection for the communication device. The method comprises installing the operational subscription profile in the subscriber module.

According to a second aspect there is presented a subscriber module for operational subscription profile download and installation. The subscriber module is provided in a communication device. The subscriber module is provided with subscription data for use in establishing initial cellular connectivity. The subscriber module comprises processing circuitry. The processing circuitry is configured to cause the subscriber module to obtain download information for the operational subscription profile from an eSIM server and over an initial cellular connectivity connection for the communication device. The download information is used by the subscriber module when determining that subscription profile download is authorized for the subscriber module. The subscriber module authenticates the eSIM server using the subscription data during cellular network access authentication to establish the initial cellular connectivity connection. The processing circuitry is configured to cause the subscriber module to download the operational subscription profile from an SM-DP+ entity and in accordance with the download information. The operational subscription profile is downloaded over the initial cellular connectivity connection for the communication device. The processing circuitry is configured to cause the subscriber module to install the operational subscription profile in the subscriber module.

According to a third aspect there is presented a subscriber module for operational subscription profile download and installation. The subscriber module is provided in a communication device. The subscriber module is provided with subscription data for use in establishing initial cellular connectivity. The subscriber module comprises an obtain module configured to obtain download information for the operational subscription profile from an eSIM server and over an initial cellular connectivity connection for the communication device. The download information is used by the subscriber module when determining that subscription profile download is authorized for the subscriber module. The subscriber module authenticates the eSIM server using the subscription data during cellular network access authentication to establish the initial cellular connectivity connection. The subscriber module comprises a download module configured to download the operational subscription profile from an SM-DP+ entity and in accordance with the download information. The operational subscription profile is downloaded over the initial cellular connectivity connection for the communication device. The subscriber module comprises an install module configured to install the operational subscription profile in the subscriber module.

According to a fourth aspect there is presented a computer program for operational subscription profile download and installation. A subscriber module is provided in a communication device. The subscriber module is provided with subscription data for use in establishing initial cellular connectivity. The computer program comprises computer program code which, when run on processing circuitry of the subscriber module, causes the subscriber module to obtain download information for the operational subscription profile from an eSIM server and over an initial cellular connectivity connection for the communication device. The download information is used by the subscriber module when determining that subscription profile download is authorized for the subscriber module. During cellular network access authentication to establish the initial cellular connectivity connection the subscriber module authenticates the eSIM server using the subscription data. The computer program comprises computer program code which, when run on processing circuitry of the subscriber module, causes the subscriber module to download the operational subscription profile from an SM-DP+ entity and in accordance with the download information. The operational subscription profile is downloaded over the initial cellular connectivity connection for the communication device. The computer program comprises computer program code which, when run on processing circuitry of the subscriber module, causes the subscriber module to install the operational subscription profile in the subscriber module.

According to a fifth aspect there is presented a method for enabling operational subscription profile download and installation to a subscriber module. The method is performed by an eSIM server. The method comprises obtaining a trigger for the operational subscription profile to be downloaded to the subscriber module. The method comprises providing, towards the subscriber module and over an initial cellular connectivity connection for a communication device in which the subscriber module is provided, download information for the operational subscription profile. The download information is specified for the subscriber module to determine that subscription profile download is authorized for the subscriber module. The eSIM server provides authentication data towards the subscriber module for the subscriber module to authenticate the eSIM server during cellular network access authentication to establish the initial cellular connectivity connection.

According to a sixth aspect there is presented an eSIM server for enabling operational subscription profile download and installation to a subscriber module. The eSIM server comprises processing circuitry. The processing circuitry is configured to cause the eSIM server to obtain a trigger for the operational subscription profile to be downloaded to the subscriber module. The processing circuitry is configured to cause the eSIM server to provide, towards the subscriber module and over an initial cellular connectivity connection for a communication device in which the subscriber module is provided, download information for the operational subscription profile. The download information is specified for the subscriber module to determine that subscription profile download is authorized for the subscriber module. The eSIM server provides authentication data towards the subscriber module for the subscriber module to authenticate the eSIM server during cellular network access authentication to establish the initial cellular connectivity connection.

According to a seventh aspect there is presented an eSIM server for enabling operational subscription profile download and installation to a subscriber module. The eSIM server comprises an obtain module configured to obtain a trigger for the operational subscription profile to be downloaded to the subscriber module. The eSIM server comprises a provide module configured to provide, towards the subscriber module and over an initial cellular connectivity connection for a communication device in which the subscriber module is provided, download information for the operational subscription profile. The download information is specified for the subscriber module to determine that subscription profile download is authorized for the subscriber module. The eSIM server provides authentication data towards the subscriber module for the subscriber module to authenticate the eSIM server during cellular network access authentication to establish the initial cellular connectivity connection.

According to an eighth aspect there is presented a computer program for enabling operational subscription profile download and installation to a subscriber module. The computer program comprises computer program code which. The computer program code, when run on processing circuitry of an eSIM server, causes the eSIM server to obtain a trigger for the operational subscription profile to be downloaded to the subscriber module. The computer program code, when run on processing circuitry of the eSIM server, causes the eSIM server to provide, towards the subscriber module and over an initial cellular connectivity connection for a communication device in which the subscriber module is provided, download information for the operational subscription profile. The download information is specified for the subscriber module to determine that subscription profile download is authorized for the subscriber module. The eSIM server provides authentication data towards the subscriber module for the subscriber module to authenticate the eSIM server during cellular network access authentication to establish the initial cellular connectivity connection.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

A tenth aspect relates to a communication device which comprises a subscriber module according to the second or third aspects.

Advantageously, these aspects provide a secure procedure for subscription profile download to, and installation in, a communication device, where the above issues are avoided.

Advantageously, these aspects mitigate rogue subscription profiles from being downloaded to, and installed in, a subscriber module of a communication device.

Advantageously, these aspects enable automated handling of the download information, without involvement from the device owner, or user, thereby enabling automated provisioning of operational subscription profiles.

Advantageously, these aspects enable automated later/subsequent configuration of information in the subscriber module for use with subscription profile download using the above disclosed option 2 and option 3. Such information includes SM-DP+/SM-DS object identifier (OID) and address.

Other objectives, features and advantages of the enclosed embodiments will be apparent from the following detailed disclosure, from the claims as well as from the drawings.

Generally, all terms used in the embodiments and claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIGS. 2 and 3 are flowcharts of methods according to embodiments;

FIGS. 4 to 11 are sequence diagrams according to embodiments;

FIG. 12 is a schematic diagram showing functional units of a subscriber module according to an embodiment;

FIG. 13 is a schematic diagram showing functional modules of a subscriber module according to an embodiment;

FIG. 14 is a schematic diagram showing functional units of an eSIM server according to an embodiment;

FIG. 15 is a schematic diagram showing functional modules of an eSIM server according to an embodiment; and

FIG. 16 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

The wording that a certain data item or piece of information is obtained by a first device should be construed as that data item or piece of information being retrieved, fetched, received, or otherwise made available to the first device. For example, the data item or piece of information might either be pushed to the first device from a second device or pulled by the first device from a second device. Further, in order for the first device to obtain the data item or piece of information, the first device might be configured to perform a series of operations, possible including interaction with the second device. Such operations, or interactions, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the first device.

The wording that a certain data item or piece of information is provided by a first device to a second device should be construed as that data item or piece of information being sent or otherwise made available to the second device by the first device. For example, the data item or piece of information might either be pushed to the second device from the first device or pulled by the second device from the second device. Further, in order for the first device to provide the data item or piece of information to the second device, the first device and the second device might be configured to perform a series of operations in order to interact with each other. Such operations, or interaction, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the second device.

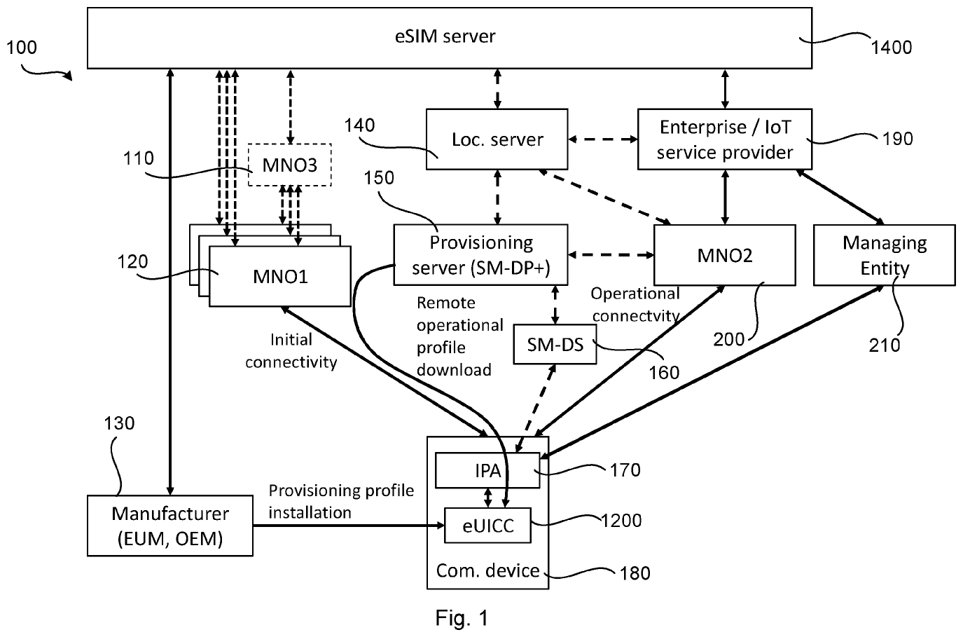

FIG. 1 is a schematic diagram illustrating a communication network 100 where embodiments presented herein can be applied.

A communication device 180 is the device to which an operational subscription profile is to be downloaded. The communication device 180 may be a mobile phone, a laptop, a computer tablet or a user equipment (UE). It may alternatively be an IoT device. The communication device 180 comprises a subscriber module 1200, such as an iUICC or eUICC or ieUICC (as exemplified by an eUICC in the figure), supporting remote provisioning of subscription profiles according to the GSMA consumer variant, including the signed Subscription Profile State Management Operations according to the GSMA eSIM IoT Architecture (as specified in the aforementioned document “SGP.31—eSIM IoT Architecture and Requirements v1.0”). The communication device 180 supports secure subscription profile download, installation, and enabling where authorization secrets are leveraged, or where download and installation data is used. The subscriber module 1200 holds credentials for secure interaction with both provisioning servers (such as an SM-DP+ entity 150), and discovery servers (such as an SM-DS entity 160). The credentials comprise an elliptic curve (EC) private key and a subscriber module 1200 certificate containing the corresponding public key. The subscriber module 1200 certificate also contains a subscriber module 1200 identifier, such as an EID. The subscriber module 1200 is provisioned with a first profile in the form of a provisioning subscription profile at manufacturing, or, personalization or module/device manufacturing. The provisioning subscription profile provides initial cellular connectivity to allow download of an operational subscription profile. Alternatively, if there is no subscription profile installed in the subscriber module 1200, the subscriber module 1200 operating system (OS) may act as a provisioning subscription profile in initial cellular connectivity establishment. The communication device 180 might be manufactured by an original equipment manufacturer (OEM) and the subscriber module 120 might be manufactured by an eUICC manufacturer (EUM), as both represented by a manufacturer entity 130.

Management of subscription profiles (e.g., enable, disable, and delete of subscriber subscription profiles) on the subscriber module 1200 is remotely handled by a managing entity 210. The managing entity 210 may also handle device and data management for the communication device 180. When the communication device 180 boots up for the first time, information to connect to the managing entity 210 may not yet have been configured. Such information may for example be obtained by the communication device 180 via the operational subscription profile or via an application layer bootstrapping procedure.

The communication device 180 comprises a cellular modem configured to connect to a mobile network based on the active subscription profile. For the first start-up of the communication device 180 the provisioning subscription profile is the active subscription profile and provides initial cellular connectivity. Initial cellular connectivity is established using a first mobile network (MNO1 120). Using eSIM remote SIM provisioning the subscriber module 1200 may then be provisioned with a second profile in the form of an operational subscription profile from a second mobile network (MNO2 200). It is here noted that MNO1 120 and MNO2 200 may be one and the same network, but may in other embodiments be different networks. The terms MNO1, MNO2 and MNO3 may also in the following description in some instances be used interchangeably also for mobile network operators and their respective mobile networks. After the operational subscription profile has been activated, the operational subscription profile is used to provide network connectivity for the communication device 180. In other words, the operational subscription profile is intended for use more long-term (than the provisioning subscription profile) for connectivity service(s) for the communication device 180. The operational subscription profile comprises in an embodiment MNO data and applications for the purpose of providing services by the MNO. The operational subscription profile is in the embodiment supporting a subscription with the MNO and allow connectivity to a mobile network, which in the above illustration is typically the MNO2 200. The operational subscription profile may further comprise one or more applications for non-telecommunication services. The provisioning subscription profile is in an embodiment comprising a combination of MNO data and applications for the purpose of enabling connectivity to the MNO1 120 solely for the purpose of the provisioning of the operational subscription profile on the subscriber module 1200. The provisioning subscription profile thus contains information/applications which is not present in the operational subscription profile, such as information about how to download the operational subscription profile.

The communication device 180 comprises, typically as part of the modem, an IoT Subscription profile Assistant (IPA) 170 that assists in subscription profile download and subscription profile management operations. The IPA 170 interacts with the provisioning server for subscription profile download and notification handling and with the managing entity for subscription profile management operations. The IPA 170 may be configured to interact with a discovery service to check for pending subscription profile download events. In case the communication device 180 is network constrained, energy constrained and/or memory constrained the interaction with the SM-DP+ entity 150 and SM-DS entity 160 may be via the managing entity 210.

The eSIM server 1400 serves as the home mobile network when the communication device 180 connects to a first mobile network (i.e., a visiting/serving mobile network) during its first start-up to gain initial cellular connectivity. The eSIM server 1400 provides a provisioning subscription profile that is installed during subscriber module 1200 manufacturing, or personalization. This may be a subscription profile that is common for all communication devices 180 using the service. Alternatively, one individual subscription profile per communication device 180 is used. The provider of the eSIM server 1400 may for example be a Mobile Network Operator, a Communication Service Provider (CSP), a Mobile Virtual Network Operator (MVNO), or a mobile network vendor. The provider of the eSIM server 1400 might have an agreement with an MNO (shown as mobile network MNO3 110 in the figure) to use a set of international mobile subscriber identities (IMSIs) for its eSIM server 1400 such that communication devices like communication device 180 can be routed to the eSIM server 1400 during initial cellular connectivity establishment.

An MNO (or CSP) provides cellular connectivity for communication devices and potentially also localization server 140s for remote subscription profile download. The eSIM server 1400 provider, in case of being an MVNO, has roaming agreements with a set of MNOs (indicated as mobile network MNO1 120 in the figure) that assists in providing initial cellular connectivity for a communication device 180 using the eSIM server 1400.

Enterprises, IoT service providers, device owners or end-users that are using the eSIM server 1400 order subscription profile(s) for their communication devices 180 from an MNO (shown as the mobile network MNO2 200 in the figure). This MNO interacts with the provisioning server for the preparation of operational subscription profiles for remote download. Upon successful download and activation of the of an operational subscription profile into a communication device 180, the MNO provides cellular connectivity for the communication device 180. Note that MNO2 200 may be one of the MNO1 120 operators providing initial cellular connectivity.

The SM-DP+ entity 150 handles subscription profile download to the IoT devices according to the GSMA eSIM consumer variant. The SM-DP+ entity 150 is either operated by the MNO providing the operational subscription profile to be downloaded (illustrated as mobile network MNO2 200 in the figure) or a third party trusted by the MNO. The SM-DP+ entity 150 is certified and has obtained certificates allowing it to be part of the eSIM ecosystem. The SM-DP+ certificate for authentication and the certificate for subscription profile download contains an SM-DP+ OID. This OID is used to ensure communication is with the intended SM-DP+ entity 150.

The SM-DS entity 160 provides a discovery service for use by the communication devices 180 according to the aforementioned documents “SGP.21—RSP Architecture Specification v2.4” and “SGP.22—RSP Technical Specification v2.4”. GSMA has currently specified a root SM-DS for the eSIM ecosystem. There may, however, be subsidiary SM-DS entities, and vendor specific SM-DS entities. The SM-DS entity 160 is certified and has obtained one or more certificates allowing it to be part of the eSIM ecosystem. The SM-DS certificate for authentication contains an SM-DS OID. This OID is used to ensure communication is with the intended SM-DS entity 160.

As part of providing initial cellular connectivity a localization server 140 may determine the proper MNO/MNO device to provide the operational subscription profile for a particular communication device 180. This is referred to as the localization process which may be more complex or less complex depending on the scenario at hand. For example, based on geographical location of the communication device 180, knowledge of pre-negotiated agreements with MNOs, communication device 180 information, etc., the proper MNO, provisioning server, and operational subscription profile to be used are determined. Such localization may be offered as a service to enterprises, or communication service providers 190, by a localization server 140 provider.

There may be different ways in how the localization server 140 is provided and how it is connected to the eSIM server 1400. In a first option the localization server 140 is managing connectivity for a set of MNOs and handles the interaction with provisioning servers on behalf of the MNOs (the provisioning server may even be offered by the localization server 140 provider) and also updates/controls the Home Subscriber Server (HSS) or similar (such as a Unified Data Management (UDM) in a 5G core network (5GC) of the MNO. In a second option the localization server 140 is simply performing the localization based on input data and the enterprise itself is handling interaction with MNOs. Other options are also possible. The eSIM server 1400 may either be closely connected to the localization server 140 (or part of it), e.g., in the first option, or it may have no relation and only use a localization application programming interface (API) to trigger localization and receive information about the chosen operational subscription profile. Such interaction may also be via the enterprise.

The managing entity 210 manages one or more subscription profiles on the subscriber module 1200 of the communication device 180. The managing entity 210 may also assist in subscription profile download interactions between the communication device 180 and the SM-DS entity 160. The managing entity 210 supports signed Subscription profile State Management Operations (PSMOs) using a managing entity 210 private key, such as an EC private key, whose corresponding public key, such as an EC public key is configured into each subscriber module 1200 managed by the managing entity 210. The managing entity 210 is configured with a list of subscriber module 1200 identifiers (such as EIDs) of communication devices 180, or subscriber module 1200s, managed by the managing entity 210. The device owner/end-user/enterprise/service provider or other actor may interact with the managing entity 210 to configure it with management operations. Such information may for example include the ICCID of a subscription profile of a particular subscriber module 1200 for which a particular subscription profile management operation shall be performed or may include an Activation Code (AC) with information from where a particular communication device 180 shall download a subscription profile.

The embodiments disclosed herein relate to techniques for operational subscription profile download and installation to a subscriber module 1200. In order to obtain such techniques there is provided a subscriber module 1200, a method performed by the subscriber module 1200, a computer program product comprising code, for example in the form of a computer program, that when run on processing circuitry of the subscriber module 1200, causes the subscriber module 1200 to perform the method. In order to obtain such techniques there is further provided an eSIM server 1400, a method performed by the eSIM server 1400, and a computer program product comprising code, for example in the form of a computer program, that when run on processing circuitry of the eSIM server 1400, causes the eSIM server 1400 to perform the method.

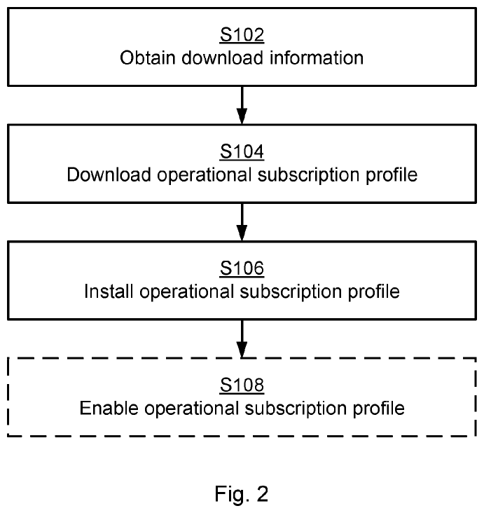

Reference is now made to FIG. 2 illustrating a method for operational subscription profile download and installation as performed by the subscriber module 1200 according to an embodiment. The subscriber module 1200 is provided in a communication device 180. The subscriber module 1200 is provided with subscription data for use in establishing initial cellular connectivity.

S102: The subscriber module 1200 obtains download information for the operational subscription profile from the eSIM server 1400. The download information is obtained over an initial cellular connectivity connection for the communication device 180. The download information is used by the subscriber module 1200 when determining that subscription profile download is authorized for the subscriber module 1200. The subscriber module 1200 authenticates the eSIM server 1400 using the subscription data during cellular network access authentication to establish the initial cellular connectivity connection.

S104: The subscriber module 1200 downloads the operational subscription profile from the SM-DP+ entity 150 and in accordance with the download information. The operational subscription profile is downloaded over the initial cellular connectivity connection for the communication device 180.

S106: The subscriber module 1200 installs the operational subscription profile in the subscriber module 1200.

Embodiments relating to further details of operational subscription profile download and installation as performed by the subscriber module 1200 will now be disclosed.

In some embodiments, after S106, the operational subscription profile is enabled upon having been downloaded and installed (and stored). Thus, in some embodiments, the subscriber module 1200 is configured to perform (optional) step S108.

S108: The subscriber module 1200 enables the operational subscription profile in the subscriber module 1200 upon having installed the operational subscription profile.

The network access authentication might rely on a shared secret between the eSIM server 1400 and the provisioning profile (as accessed by the subscriber module 1200). The shared secret might be a pre-configured part of the provisioning profile or be derived from data contained in the provisioning profile. Thus, in some examples, the authentication of the eSIM server 1400 is performed using a secret shared with the eSIM server 1400 contained in, or derivable from, the subscription data. In some examples, the subscription data is contained in a provisioning subscription profile installed in the subscriber module 1200. In some examples, the subscription data is contained as part of the subscriber module 1200 operating system. The subscriber module 1200 then, when no subscription profile is installed in the subscriber module 1200, uses the subscription data to act towards the communication device 180 as if a provisioning profile were present in the subscriber module 1200. In some examples, the secret shared with the eSIM server 1400 for securing transfer of the download information from the eSIM server 1400 to the subscriber module 1200 over the initial cellular connectivity connection for the communication device 180 is contained in, or derivable from, the subscription data. In some examples, the secret shared with the eSIM server 1400 is derivable from the subscription data based on a private key of a private-public key pair of the subscriber module 1200 and a public key of a private-public key pair of the eSIM server 1400. The public key of the private-public key pair of the eSIM server 1400 is part of the subscription data.

In some examples, the download information is securely transferred from the eSIM server 1400 to the subscriber module 1200 using a SIM over-the-air (OTA) procedure. The operational subscription profile might be downloaded from a default SM-DP+ entity 150 or an SM-DP+ entity 150 given by an SM-DS entity 160. If the SM-DS entity 160 is used, then the SM-DP+ information from where the operational subscription profile is to be downloaded is first securely obtained from the SM-DS. The authorization secret is used to ensure the operational subscription profile download is authorized for the subscriber module 1200. Hence, in some examples, the download information specifies an authorization secret used by the subscriber module 1200 to determine that the download of the operational subscription profile from the SM-DP+ entity is authorized and/or to determine that the download of SM-DP+ information from the SM-DS specifying the SM-DP+ entity 150 from which the operational subscription profile is to be downloaded is authorized. Determining that the download is authorized is then based on the subscriber module 1200 obtaining proof of the SM-DP+/SM-DS knowledge of the authorization secret as obtained during profile download preparation for the operational subscription profile.

In some examples, the download of the operational subscription profile is secured by leveraging SM-DS or SM-DP+ information (such as address and OID) in the subscriber module 1200. The SM-DS or SM-DP+ information is used by the subscriber module 1200 to verify information obtained from the SM-DP+, and SM-DS if used, during the operational profile download to determine that the profile download is authorized. The SM-DS or SM-DP+ information is selected by the communication device 180 using unsigned download and installation data pointing to SM-DS or SM-DP+ information. Thus, in some examples, the download information identifies an OID of the SM-DP+ entity 150 and/or an SM-DS entity 160, for the subscriber module 1200 to use when downloading and installing the operational subscription profile. In some examples, the SM-DP+ entity 150 from which the operational subscription profile is downloaded is either given by the OID identified by the download information when the OID is of the SM-DP+ entity 150, or is given by an event record received by the subscriber module 1200 from the SM-DS entity 160 when the OID identified by the download information is of the SM-DS entity 160. The SM-DS entity 160 is then given by the OID identified by the download information.

The Authentication and Key Agreement (AKA) protocol, such as enabled through UMTS-AKA, IMS-AKA, 5G AKA or Extensible Authentication Protocol-AKA′, as run between the subscriber module 1200 and the eSIM server 1400 for authenticating the communication device 180 to obtain initial cellular connectivity might be leveraged to securely transfer the download information. Thus, in some examples, the download information is obtained as part of performing network access authentication, using the AKA protocol, when establishing the initial cellular connectivity connection.

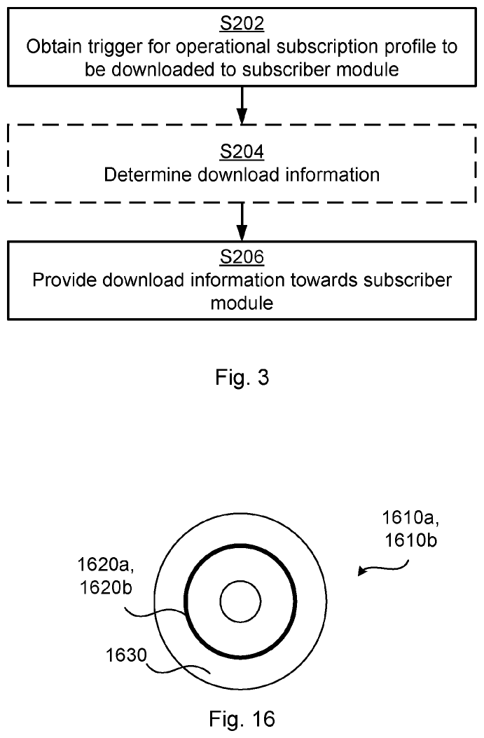

Reference is now made to FIG. 3 illustrating a method for enabling operational subscription profile download and installation to a subscriber module 1200 as performed by the eSIM server 1400 according to an embodiment.

S202: The eSIM sever obtains a trigger for the operational subscription profile to be downloaded to the subscriber module 1200.

S206: The eSIM server 1400 provides, towards the subscriber module 1200 and over an initial cellular connectivity connection for a communication device 180 in which the subscriber module 1200 is provided, download information for the operational subscription profile. The download information is specified for the subscriber module 1200 to determine that subscription profile download is authorized for the subscriber module 1200. The eSIM server 1400 provides authentication data towards the subscriber module 1200 for the subscriber module 1200 to authenticate the eSIM server 1400 during cellular network access authentication to establish the initial cellular connectivity connection.

Embodiments relating to further details of enabling operational subscription profile download and installation to the subscriber module 1200 as performed by the eSIM server 1400 will now be disclosed.

The trigger obtained in S202 can be in the form of network access authentication triggered at the eSIM server 1400. This is in turn triggered by a subscription identifier, such as an IMSI or a Network Access Identifier (NAI), being provided/received from the subscriber module 1200 via the communication device 180 and the serving network to the eSIM server 1400.

In some aspects, the download information is generated, or determined, by the eSIM service at profile download preparation. Hence, in some embodiments, the eSIM server 1400 is configured to perform (optional) step S204.

S204: The eSIM server 1400 determines the download information during profile download preparation for the operational subscription profile.

It is here noted that step S204 might be performed either after step S202 (as in FIG. 3) or before step S202, i.e., after or before the trigger in S202 has been obtained.

As disclosed above, in some examples, the authentication data provided by the eSIM server 1400 towards the subscriber module 1200 is derived using a secret shared (thus a shared secret) with the subscriber module 1200. As disclosed above, in some examples, transfer of the download information from the eSIM server 1400 to the subscriber module 1200 over the initial cellular connectivity connection for the communication device 180 is secured using the secret shared with the subscriber module 1200. As disclosed above, in some examples, the secret shared with the subscriber module 1200 is based on a public key of a private-public key pair of the subscriber module 1200 and a private key of a private-public key pair of the eSIM server 1400. As disclosed above, in some examples, the download information is securely transferred from the eSIM server 1400 to the subscriber module 1200 using a SIM OTA procedure.

As disclosed above, in some examples, the download information specifies an authorization secret for use by the subscriber module 1200 to determine that the download of the operational subscription profile from the SM-DP+ entity is authorized and/or to determine that the download of SM-DP+ information from the SM-DS specifying the SM-DP+ entity 150 from which the operational subscription profile is to be downloaded is authorized. Determining that the download is authorized is based on the subscriber module 1200 obtaining proof of the SM-DP+/SM-DS knowledge of the authorization secret as obtained during profile download preparation for the operational subscription profile.

As disclosed above, in some examples, the download information identifies an OID of an SM-DP+ entity 150 and/or an SM-DS entity 160, for the subscriber module 1200 to use when downloading and installing the operational subscription profile. As disclosed above, in some examples, the SM-DP+ entity 150 from which the operational subscription profile is downloaded is either given by the OID identified by the download information when the OID is of the SM-DP+ entity 150, or is given by an event record received by the subscriber module 1200 from the SM-DS entity 160 when the OID identified by the download information is of the SM-DS entity 160. The SM-DS entity 160 is given by the OID identified by the download information.

As disclosed above, in some examples, the download information is provided as part of performing network access authentication, using the AKA protocol, when establishing the initial cellular connectivity connection. In some examples, the download information is provided in an authentication vector.

In the below examples, the subscriber module 1200 will, for non-limiting and illustrative purposes, be represented by an eUICC. However, the below examples are also applicable for other types of subscriber module 1200s already having been mentioned in the present disclosure.

In the below examples, the communication device 180 will, for non-limiting and illustrative purposes, be represented by an IoT device. However, the below examples are also applicable for other types of communication devices 180 already having been mentioned in the present disclosure. A communication device in the form of an IoT device may be a device for use in one or more application domains, these domains comprising, but not limited to, home, city, wearable technology, extended reality, industrial application, and healthcare. By way of example, the IoT device for a home, an office, a building or an infrastructure may be a baking scale, a coffee machine, a grill, a fridge, a refrigerator, a freezer, a microwave oven, an oven, a toaster, a water tap, a water heater, a water geyser, a sauna, a vacuum cleaner, a washer, a dryer, a dishwasher, a door, a window, a curtain, a blind, a furniture, a light bulb, a fan, an air-conditioner, a cooler, an air purifier, a humidifier, a speaker, a television, a laptop, a personal computer, a gaming console, a remote control, a vent, an iron, a steamer, a pressure cooker, a stove, an electric stove, a hair dryer, a hair styler, a mirror, a printer, a scanner, a photocopier, a projector, a hologram projector, a 3D printer, a drill, a hand-dryer, an alarm clock, a clock, a security camera, a smoke alarm, a fire alarm, a connected doorbell, an electronic door lock, a lawnmower, a thermostat, a plug, an irrigation control device, a flood sensor, a moisture sensor, a motion detector, a weather station, an electricity meter, a water meter, and a gas meter.

By further ways of example, the IoT device for use in a city, urban, or rural areas may be connected street lighting, a connected traffic light, a traffic camera, a connected road sign, an air control/monitor, a noise level detector, a transport congestion monitoring device, a transport controlling device, an automated toll payment device, a parking payment device, a sensor for monitoring parking usage, a traffic management device, a digital kiosk, a bin, an air quality monitoring sensor, a bridge condition monitoring sensor, a fire hydrant, a manhole sensor, a tarmac sensor, a water fountain sensor, a connected closed circuit television, a scooter, a hoverboard, a ticketing machine, a ticket barrier, a metro rail, a metro station device, a passenger information panel, an onboard camera, and other connected device on a public transport vehicle.

As further way of example, the communication IoT device may be a wearable device, or a device related to extended reality, wherein the device related to extended reality may be a device related to augmented reality, virtual reality, merged reality, or mixed reality. Examples of such IoT devices may be a smart-band, an activity tracker, a haptic glove, a haptic suit, a smartwatch, clothes, eyeglasses, a head mounted display, an ear pod, an activity monitor, a fitness monitor, a heart rate monitor, a ring, a key tracker, a blood glucose meter, and a pressure meter.

As further ways of example, the IoT device may be an industrial application device wherein an industrial application device may be an industrial unmanned aerial vehicle, an intelligent industrial robot, a vehicle assembly robot, and an automated guided vehicle.

As further ways of example, the IoT device may be a transportation vehicle, wherein a transportation vehicle may be a bicycle, a motor bike, a scooter, a moped, an auto rickshaw, a rail transport, a train, a tram, a bus, a car, a truck, an airplane, a boat, a ship, a ski board, a snowboard, a snow mobile, a hoverboard, a skateboard, roller-skates, a vehicle for freight transportation, a drone, a robot, a stratospheric aircraft, an aircraft, a helicopter and a hovercraft.

As further ways of example, the IoT device may be a health or fitness device, wherein a health or fitness device may be a surgical robot, an implantable medical device, a non-invasive medical device, and a stationary medical device which may be: an in-vitro diagnostic device, a radiology device, a diagnostic imaging device, and an x-ray device.

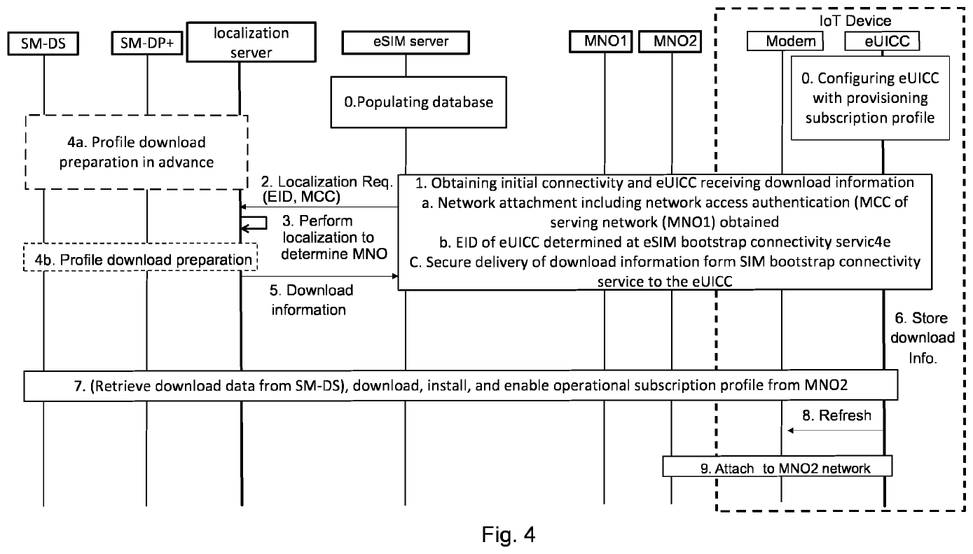

General aspects of secure download of an operational subscription profile using download information obtained by the eUICC leveraging the eSIM server will be disclosed next with reference to the sequence diagram of FIG. 4.

With reference to FIG. 4 is described a procedure for an IoT device to obtain initial cellular connectivity and for the IoT device to download a first operational subscription profile. The download information needed for secure download (e.g., in presence of malware) of this operational subscription profile is determined, or generated, during the subscription profile download preparation phase and is provided to the eUICC leveraging the eSIM server that is part of providing initial cellular connectivity to the IoT device.

It is assumed (step 0) that the database of the eSIM server is populated with EIDs for each IoT device using the eSIM server. The eUICC of each IoT device is configured with a provisioning subscription profile from the eSIM server. This subscription profile is the current active subscription profile of the eUICC. The IoT device wakes up (e.g., for the first time) and connects to MNO1 leveraging the provisioning subscription profile of the eUICC, performs network access authentication and obtains initial cellular connectivity (step 1a). Typically, roaming is used and the eSIM server is acting as home operator and handles the network access authentication. MNO1 determines the eSIM server (or MNO3 if eSIM server has agreement with MNO3 to use a particular IMSI range) based on the IMSI provided by the IoT device.

The network access authentication performed as part of step 1a relies on a shared secret that is shared between the eSIM server and the provisioning subscription profile. In order to select the correct shared secret, and to trigger localization in step 2, the eSIM server determines in step 1b the EID of the eUICC. This may be done based on the received IMSI, e.g., a mapping between IMSI and EID is held in the eSIM server or the EID may be transferred from the eUICC to the eSIM server during the network access authentication (step 1b performed in combination with step 1a).

To prepare for the download of a suitable operational subscription profile for the IoT device, the eSIM server requests (in step 2) localization to be performed by the localization server. The EID of the eUICC of the IoT device and optionally also the MCC (+MNC) of MNO1 (country/region where the IoT device is located) are provided for use in the localization. The eSIM server does not necessarily interact directly with the entity performing the localization as shown here. The localization mechanism is performed in step 3 and an MNO to provide an operational subscription profile is determined, denoted MNO2 in the figure. Either an operational subscription profile from MNO2 is prepared for download in advance (step 4a), e.g., for a whole batch of IoT devices, or the localization server interacts directly with an SM-DP+ (step 4b), or via an MNO/CSP, to prepare a subscription profile for download. If SM-DS is to be used, an event is registered at the SM-DS.

When an operational subscription profile is determined and prepared for download, download information needed for secure download of the subscription profile is securely provided from the localization server to the eSIM server (step 5) and further to the eUICC (step 1c). Depending on the method used to securely transfer the download information, the transfer either occurs as part of obtaining the initial cellular connectivity (in combination with step 1a) or after initial cellular connectivity is obtained leveraging this connectivity for the transfer of the download information. In the first case, steps 2-5 are performed while initial cellular connectivity establishment is ongoing, whereas in the other case these steps are typically performed after initial cellular connectivity has been established.

After receiving the download information, the eUICC stores (step 6), with the help eUICC OS commands, the download information into the ISD-R security domain for use during download of the operational subscription profile. In step 7 the modem, with the help of eUICC and the obtained download information, securely downloads the operational subscription profile from an SM-DP+ given by information in the IoT device and/or the eUICC. If SM-DS is used then SM-DP+ info from where to download the subscription profile is first securely obtained from the SM-DS. Upon successful download, the subscription profile is installed and automatically enabled. The provisioning subscription profile then uses the refresh command (step 8) which triggers the modem to detach from the current network and drop all cached information related to that network. The modem then uses the newly installed and enabled operational subscription profile to attach the MNO2 network and gain connectivity (step 9).

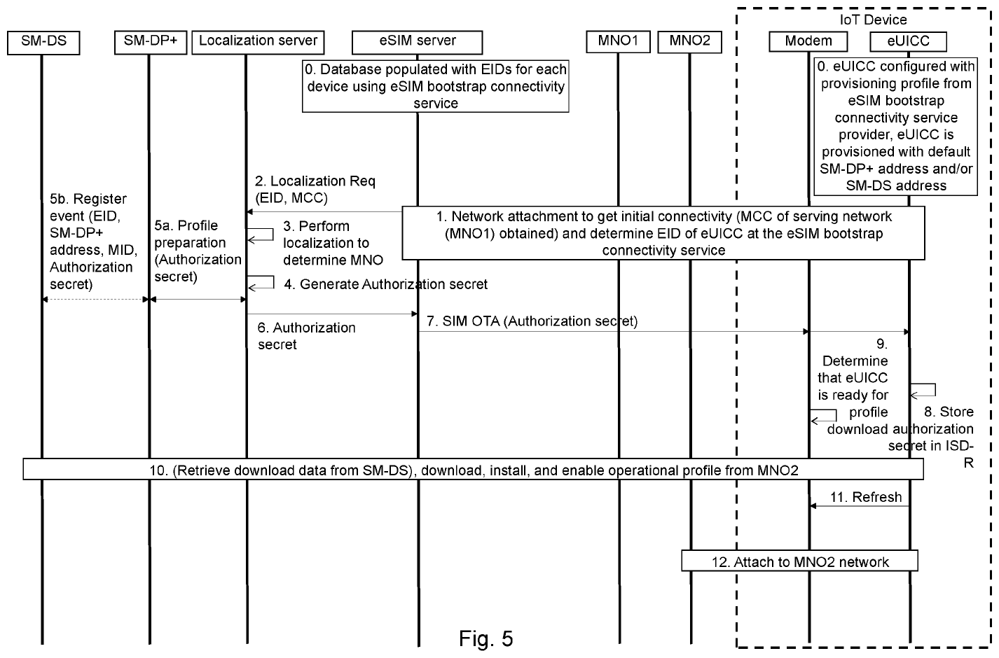

With reference next to the sequence diagram of FIG. 5, an example will be described where download of the first operational subscription profile is secured using an authorization secret. The authorization secret is generated during subscription profile download preparation by the localization server and is provided to the eUICC leveraging the eSIM server using a SIM OTA procedure.

Step 0: The database of the eSIM server is populated with EIDs for each IoT device using the eSIM server for a bootstrap connectivity service. The eUICC of each IoT device using the service is configured with a provisioning subscription profile from the eSIM server. This subscription profile is the current active subscription profile of the eUICC. The eUICC is provisioned with the default SM-DP+ address and/or SM-DS address.

Step 1: The IoT device connects to MNO1 leveraging the provisioning subscription profile of the eUICC, performs network access authentication and obtains initial cellular connectivity. Roaming might be used and the eSIM server is acting as home operator and handles the network access authentication. MNO1 determines the eSIM server (or MNO3 if eSIM server has agreement with MNO3 to use a particular IMSI range) based on the IMSI provided by the IoT device. The network access authentication relies on a shared secret that is shared between the eSIM server and the provisioning subscription profile. This shared secret may be pre-configured as part of the provisioning subscription profile or may be derived by the subscription module (and the eSIM server) based on the eUICC private-public key pair and an eSIM server private-public key pair wherein the public key of the eSIM server is part of the provisioning subscription profile. In the latter case, the provisioning subscription profile is configured with/comprises the eSIM server public key and the eSIM server database contains the public key (e.g., the eSIM server database contains the eUICC certificate which comprises the eUICC public key) and EID of each IoT device using the eSIM server. As is known in the art, an eUICC certificate is a certificate issued by an EUM for a specific eUICC. In order to select the correct key, and to trigger localization in step 2, the eSIM server determines the EID of the eUICC. This may be done based on the IMSI, e.g., a mapping between IMSI and EID is held in the eSIM server. If the IMSI is chosen randomly from a range of IMSIs the EID may be transferred from the eUICC to the eSIM server during the AKA authentication, as described in further detail below. In another example the EID is encoded into the IMSI. For example, in the case of 5G, the EID may be sent (in encrypted form) as part of a SUbscription Concealed Identifier (SUCI) or together with the SUCI.

Step 2: The eSIM server requests localization to be performed. The EID of the eUICC of the IoT device and optionally also the Mobile Country Code (MCC) of MNO1 (country/region where the IoT device is located) are provided as input. The eSIM server does not necessarily interact directly with the entity performing the localization as shown here.

Step 3: The localization mechanism is performed and an MNO to provide an operational subscription profile is determined, denoted MNO2 in the figure.

Step 4: An operational subscription profile from the MNO selected in step 4 needs to be prepared for download. An authorization secret for use in the operational subscription profile download preparation is randomly generated by the localization server.

Step 5: The localization server interacts directly with an SM-DP+, or via an MNO/CSP, to prepare a subscription profile for download. The authorization secret is provided to the SM-DP+ along with the EID. If SM-DS is to be used, an event is registered at the SM-DS including the authorization secret, EID, SM-DP+ information such as address and matching ID. The SM-DS here is the same as the one configured in the eUICC, and if an SM-DS is not used then the SM-DP+ here is the same as the default SM-DP+ configured in the IoT device.

Step 6: The localization server provides the authorization secret to the eSIM server.

Step 7: The eSIM server provides the authorization secret to the provisioning subscription profile of the eUICC using a SIM OTA procedure. The shared secret between the eSIM server and the provisioning subscription profile used to protect the SIM OTA procedure may be pre-configured as part of the provisioning subscription profile or may be derived by the provisioning subscription profile (and the eSIM server) based on the eUICC private-public key and an eSIM server private-public key pair.

Step 8: The eUICC stores, with the help eUICC OS commands, the authorization secret into the ISD-R security domain for use during download of the operational subscription profile.

Step 9: The modem determines that eUICC is ready for subscription profile download.

Step 10: The modem with the help of eUICC downloads a subscription profile from the default SM-DP+ where the eUICC determines that the download is authorized using an authorization secret as previously explained. If the SM-DS is used then SM-DP+ information from where to download the subscription profile is first securely obtained from the SM-DS, where the eUICC determines that the download of the SM-DP+ information obtained from the SM-DS is authorized using the authorization secret. Upon successful verification, the subscription profile is installed and automatically enabled.

Step 11: The eUICC uses the refresh command which triggers the modem to detach from the current network and drop all cached information related to that network.

Step 12: The modem uses the newly installed and enabled operational subscription profile to attach the MNO2 network and gain connectivity.

In step 0 the SM-DP+ address and/or the SM-DS address might be configured in the IoT device, such as in the modem, during device (or modem module) manufacturing instead of being configured in the eUICC during eUICC manufacturing, or personalization. This allows later configuration of the SM-DP+/SM-DS to be used during the first subscription profile download. It is also possible to provide the SM-DP+/SM-DS address to be used in step 7 together with the authorization secret.

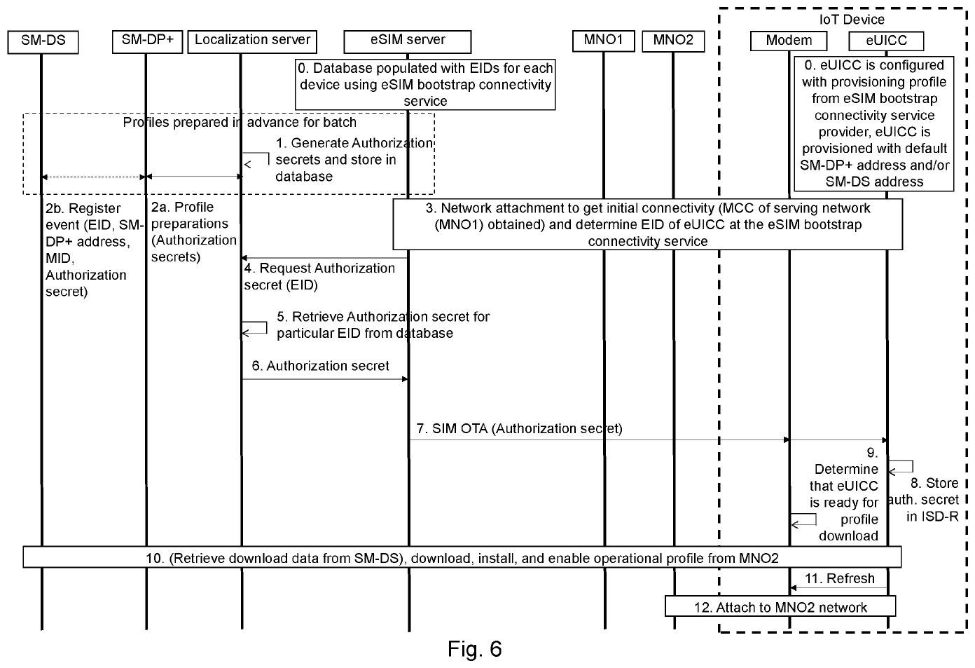

As a variant of the present example, the IoT device may belong to a batch of IoT devices for which a set of subscription profiles have already been prepared for download when the IoT device connects for the first time. Reference is next made to the sequence diagram in FIG. 6 for an illustration of this variant and where an authorization secret is used.

The steps of the sequence diagram in FIG. 6 are the same as the steps of the sequence diagram in FIG. 5 except for the following.

Step 1: The localization server generates authorization secrets for a batch of IoT devices and stores the authorization secrets in the database.

Step 2: This step is identical to step 5 of the sequence diagram in FIG. 5.

Step 3: See step 1 of the sequence diagram in FIG. 5.

Step 4: The eSIM server requests from the localization server the authorization secret for the EID obtained in step 3.

Step 5: The localization server obtains the authorization secret for the particular EID from its database.

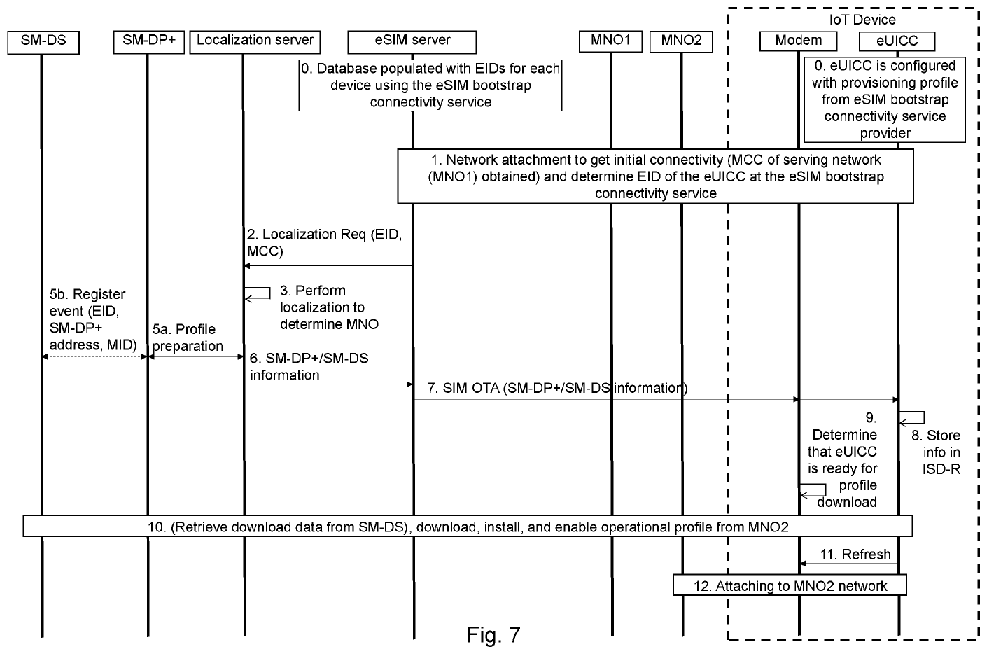

With reference next to the sequence diagram of FIG. 7, an example will be described where download of the first operational subscription profile is secured leveraging SM-DP+/SM-DS information in the eUICC to verify information obtained from the SM-DP+, and the SM-DS if used, during the operational subscription profile download to determine that the operational subscription profile download is authorized as previously described. The SM-DP+/SM-DS information is selected by the communication device using unsigned download and installation data in the device pointing to SM-DS or SM-DP+ information in the eUICC. This SM-DS/SM-DP+ information defines the download information and is determined during subscription profile download preparation by the localization server and is provided to the eUICC leveraging the eSIM server using a SIM OTA procedure. In case of SM-DP+ information being provided the information may also include the Matching ID.

The steps in the sequence diagram in FIG. 7 are the same as the steps in the sequence diagram in FIG. 5 except for the following.

Step 0: The database of the eSIM server is populated with EIDs for each IoT device using the eSIM server. The eUICC of each IoT device using the service is configured with a provisioning subscription profile from the eSIM server provider. This subscription profile is the current active subscription profile of the eUICC.

Step 4: Step 4 of the sequence diagram in FIG. 5 is not performed in the sequence diagram of FIG. 7.

Step 6: The SM-DP+ information or SM-DS information is returned by the localization server to the eSIM server. The information consists of the SM-DP+/SM-DS OID and possibly also the address. In case of SM-DP+ information being provided the information may also include the matching ID identifying the subscription profile for download at the SM-DP+. Alternatively, the ICCID may be used to uniquely identify a subscription profile.

Step 7: The eSIM server provides the SM-DP+/SM-DS information to the provisioning subscription profile of the eUICC using a SIM OTA procedure. The shared secret between the eSIM server and the provisioning subscription profile used to protect the SIM OTA procedure may be pre-configured as part of the provisioning subscription profile or may be derived by the provisioning subscription profile (and the eSIM server) based on the eUICC private-public key and an eSIM server private-public key pair.

Step 8: The eUICC stores, with the help eUICC OS commands, the SM-DP+/SM-DS information into the ISD-R security domain for use during download of the operational subscription profile.

Step 10: The modem with the help of eUICC downloads a subscription profile from the SM-DP+ where the eUICC uses SM-DP+/SM-DS information in the eUICC to verify information obtained from the SM-DP+/SM-DS during the operational subscription profile download. If the SM-DS is used then SM-DP+ information from where to download the subscription profile is first securely obtained from the SM-DS. The SM-DP+ information is used by the eUICC to verify information obtained from the SM-DP+ and from the IoT device to prevent rogue subscription profile download, installation, and enabling. For example, SM-DP+ OID, address, and matching identifier provided to the eUICC is checked against information obtained in step 7. Upon successful matching the subscription profile is downloaded, installed and automatically enabled.

The variant in FIG. 6, where the IoT device belongs to a batch of IoT devices for which a set of operational subscription profiles have already been prepared for download when the IoT device connects for the first time, is applicable also when the subscription profile download is secured using SM-DP+/SM-DS information stored in the eUICC and used to verify information obtained from the SM-DP+/SM-DS during the operational subscription profile download and where this SM-DP+/SM-DS information is obtained by the eUICC via a SIM OTA procedure.

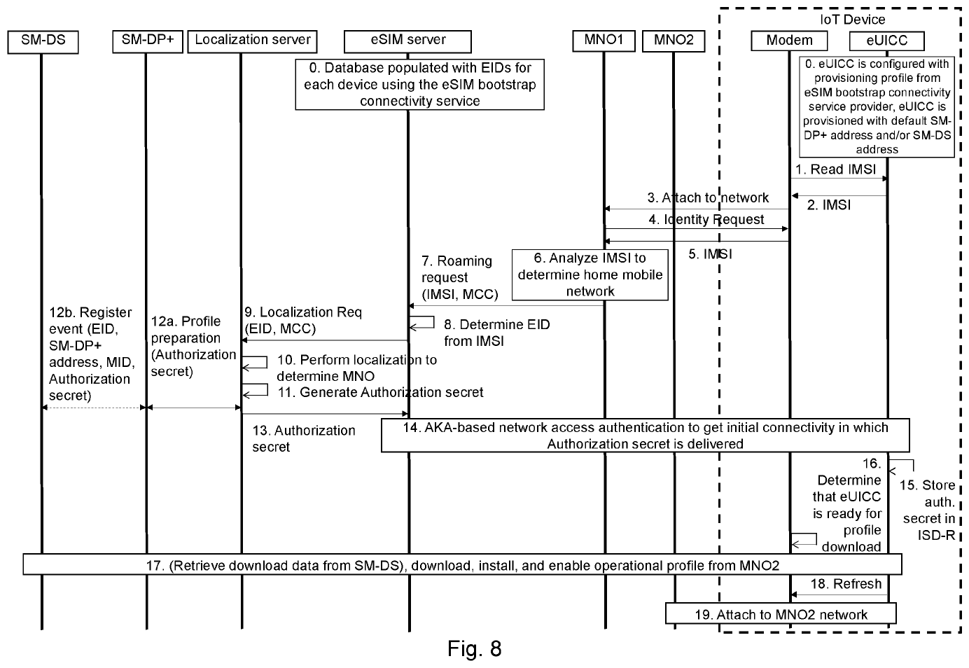

With reference next to the sequence diagram of FIG. 8, an example will be described where download of the first operational subscription profile secured is using an authorization secret to determine that the operational subscription profile download is authorized as previously described and where the authorization secret is generated during subscription profile download preparation by the localization server and is provided to the eUICC leveraging the eSIM server. In this example the authorization secret is delivered as part of running the AKA protocol.

The transfer of the authorization secret to the eUICC is performed as part of establishing initial cellular connectivity for the IoT device.

Step 0: Same as step 0 in the sequence diagram in FIG. 5.

Step 1: In order to attach to a network at first wake-up of the IoT device, the modem of the device reads IMSI from the eUICC.

Step 2: The provisioning subscription profile of the eUICC provides an IMSI to the modem. The provisioning subscription profile may be unique per IoT device and configured with a unique IMSI which is returned. Alternatively, a provisioning subscription profile common for a large set of IoT devices is used. This subscription profile may contain one or more IMSI ranges from which the provisioning subscription profile randomly selects an IMSI to be used. In yet another alternative, the provisioning subscription profile uses an IMSI range where the MCC+MNC digits, and possibly a few more digits, are fixed (pre-configured in the provisioning subscription profile) and the rest of the IMSI digits are derived from the EID of the eUICC. For example, the rest of the digits are assigned as the truncated SHA-256 hash of EID. The EID is obtained by the subscription profile using an eUICC OS function.

Step 3: The modem scans for available networks to attach to. Using the MCC+MNC from IMSI, the modem analyzes the available networks and determines MNO1 as a suitable one. The modem then requests to attach to the selected network.

Step 4: An identity request is provided from the network.

Step 5: The modem provides the IMSI as a response.

Step 6: MNO1 analyzes the IMSI to determine the home mobile network.

Step 7: A roaming request is performed to the home network. The home network is either the eSIM server acting as an MVNO, or the home network is another mobile network operator, MNO3, and where the IMSI range to which the IMSI belongs to is handled by the eSIM server. The eSIM server then controls the HSS or similar entity.

Step 8: The eSIM server determines the EID of the eUICC of the IoT device. In one alternative this is performed based on the received IMSI using a pre-configured mapping between IMSIs and EIDs stored in the eSIM server database. For example, when a unique IMSI per provisioning subscription profile is used or when the provisioning subscription profile encodes the EID into the IMSI such a database may be used. When encoding the EID into IMSI there may be several EIDs encoding into the same IMSI leading to several entries in the database being valid. How frequent such collisions occur depends on the size of the range of IMSIs and how many IoT devices are currently using the service. In case of collision the full EID value must be provided from the provisioning subscription profile to the eSIM server. This may be performed via the AKA protocol and is further described below. Also if in step 2 the IMSI in is chosen randomly from a range of IMSIs by the provisioning subscription profile, the EID is transferred from to the eSIM server via the AKA protocol.

Step 9: Same as step 2 in the sequence diagram in FIG. 5.

Step 10: Same as step 3 in the sequence diagram in FIG. 5.

Step 11: Same as step 4 in the sequence diagram in FIG. 5.

Step 12: Same as step 5 in the sequence diagram in FIG. 5.

Step 13: Same as step 6 in the sequence diagram in FIG. 5 Error! Reference source not found.

Step 14: Network access authentication is performed using the AV and following the AKA procedure based on the cellular technology being used (with small variations depending on the generation of 3GPP cellular network). The provisioning subscription profile of the eUICC and HSS of the eSIM server uses a modified behavior according to the below description but this behavior is transparent to the visiting network (MNO1) and data and message formats follows the used cellular standard. As part of network access authentication, the provisioning subscription profile of the eUICC obtains the authorization secret.

Step 14: Same as step 8 in the sequence diagram in FIG. 5.

Step 15: Same as step 9 in the sequence diagram in FIG. 5.

Step 16: Same as step 10 in the sequence diagram in FIG. 5.

Step 17: Same as step 11 in the sequence diagram in FIG. 5 Error! Reference source not found.

Step 18: Same as step 12 in the sequence diagram in FIG. 5.

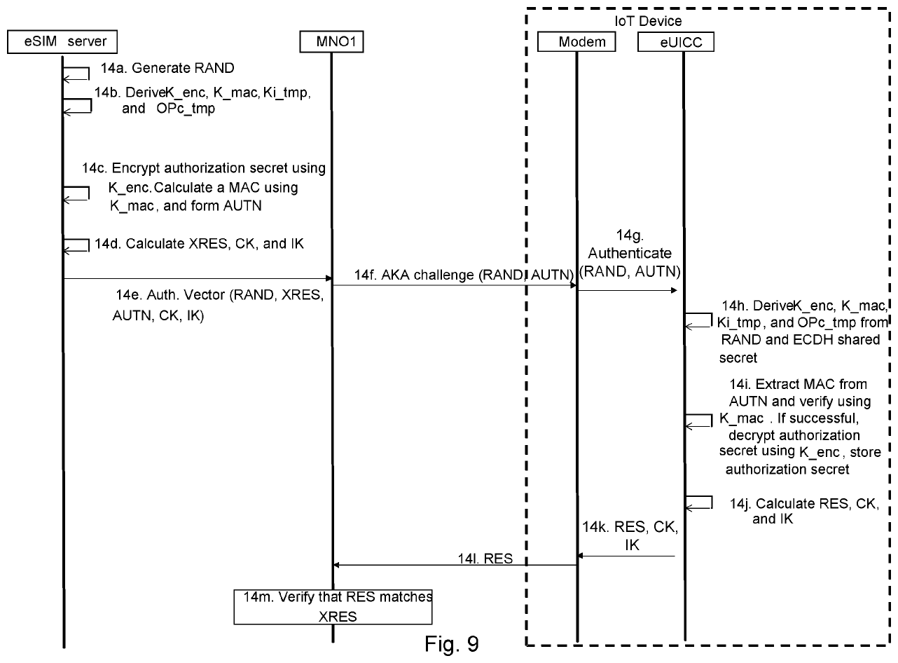

With reference next to the sequence diagram of FIG. 9, an example will, be disclosed for transferring the authorization secret from the eSIM server to the provisioning protocol using the AKA protocol. This example is based on step 14 in FIG. 8.

The authorization secret is transferred as part of the authentication vector prepared by the eSIM server. The authorization secret is both encrypted and integrity protected during the transfer. The keys used for encryption and integrity protection are derived from a shared secret between the provisioning subscription profile and the eSIM server. Preferably, the shared secret is the ECDH shared secret derived from the eUICC private-public key pair for use with eSIM and the eSIM server private-public key pair. The HSS of the eSIM server stores the eSIM server private key and obtains the eUICC public key needed to compute the shared secret from the eUICC certificate corresponding to the EID determined in step 8 in FIG. 8 and that is stored in its database. The eUICC stores the eSIM server public key and uses eUICC OS functions to derive the shared secret where the eUICC private key and the stored eSIM server public key are used. Alternatively, the provisioning subscription profile holds a global secret from which a shared secret specific for the eUICC can be derived using the EID.

In order to make the encryption key and MAC key session dependent, those keys are derived from the shared secret (ECDH or derived from the global secret) and a seed. As a seed, the random value, or challenge delivered as the RAND value as part of the Authentication Vector, can be used. The RAND might be concatenated with a string e.g., “NAA” used to separate key derivations for different purpose (see below). The ANSI-16.63-KDF algorithm might, for example, be used for the key derivation. The encryption algorithm and MAC-algorithm used for the encryption and integrity protection of IMSI might for example be the AES and HMAC-SHA-256 algorithms, respectively. The MAC algorithm may instead be the Milenage fi function where the IMSI and flags replaces SQN and AMF field given as input. The following sub-steps of step 14 are performed where the authentication vector is first created and then the AKA protocol is performed.

Step 14a: The HSS of the eSIM server generates a random value RAND for use in the authentication.

Step 14b: The eSIM server uses the RAND and the shared secret (ECDH or the one derived from global secret) according to the above description to derive encryption key K_enc and K_mac. In addition, temporary values for Ki and OPc denoted Ki_tmp and OPc_tmp are derived (using same key derivation) for use in the network access authentication. The shared secret may in other words be derived using the eUICC public key and an eSIM bootstrap connectivity service private key.

Step 14c: The authorization secret is encrypted using K_enc and integrity protected by computing a MAC using K_mac over the encrypted data. The concatenation of the encrypted data and the MAC forms the AUTN value of the authentication vector. AUTN=(encrypted data|MAC).

Step 14d: The XRES, CK, and IK values are computed according to ordinary network access authentication algorithms using RAND, Ki_tmp, and OPc_tmp as input.

Step 14e: The authentication vector (RAND, AUTN, XRES, CK, IK) is delivered from the eSIM server to the visiting mobile network (i.e., MNO1).

Step 14f: The visiting network sends RAND and AUTN as an authentication challenge to the modem of the IoT device.

Step 14g: The modem invokes the Authenticate command of the eUICC where RAND and AUTN are provided.

Step 14h: The eUICC derives the shared secret according to above and derives K_enc, K_mac, Ki_tmp, and OPc_tmp according to above description.

Step 14i: The eUICC extracts the MAC from AUTN and verifies the MAC using K_mac. If the MAC is successfully verified, the encrypted data of AUTN is extracted and decrypted to obtain the authorization secret.

Step 14j: The eUICC computes RES, CK, and IK according to ordinary network access authentication algorithms using RAND, Ki_tmp, and OPc_tmp as input.

Step 14k: The RES, CK, and IK are provided as a response to the Authenticate command.

Step 14l: The modem returns the RES to the visiting network as a response to the authentication challenge.

Step 14m: The visiting network verifies that RES equals XRES and if this is the case authentication is successful.

The size of the authorization secret might vary and for example be 64 bits. The size of the AUTN parameter might be 128 bits. The encryption might for example be performed as follows using the AES encryption algorithm: the encrypted data is obtained by first encrypting a string (e.g., “AUTN”) using K_enc, truncate the result to the size of the data to be encrypted (e.g., 64 bits), and then the logical exclusive or operation (XOR) is applied between the truncated result and the data to be encrypted. In pseudo-code this can be expressed as follows, where the final size is 64 bits:
E (authorization secret)=(authorization secret) XOR E(“AUTN”)_trunc

The MAC part of the AUTN might be represented by 64 bits, for example, based on HMAC-SHA-256 using K_mac and truncated to 64 bits. As an example, the full 128-bit AUTN could then be 64-bit encrypted authorization secret followed by the 64-bit MAC.

In case a larger authorization secret is used, e.g., 128 bits, the first half might be sent in a first AUTN, and the provisioning subscription profile, even though it successfully received the first part, signals a synchronization error, and a new authentication is performed using a new authentication vector (with new RAND) in which the second half of the authorization secret is transferred to the provisioning subscription profile. This principle can be generated to accommodate for even larger authorization secrets.

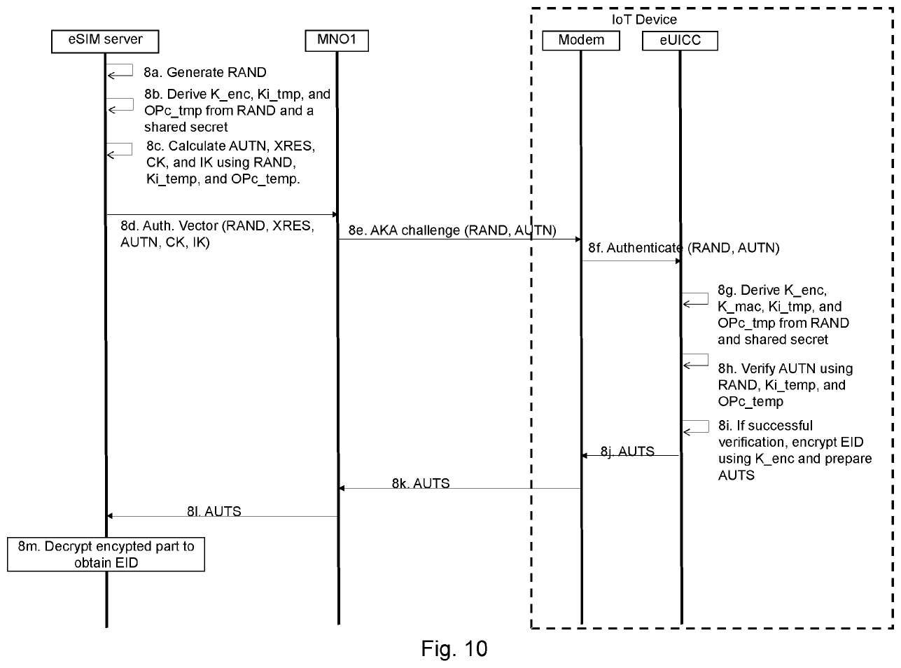

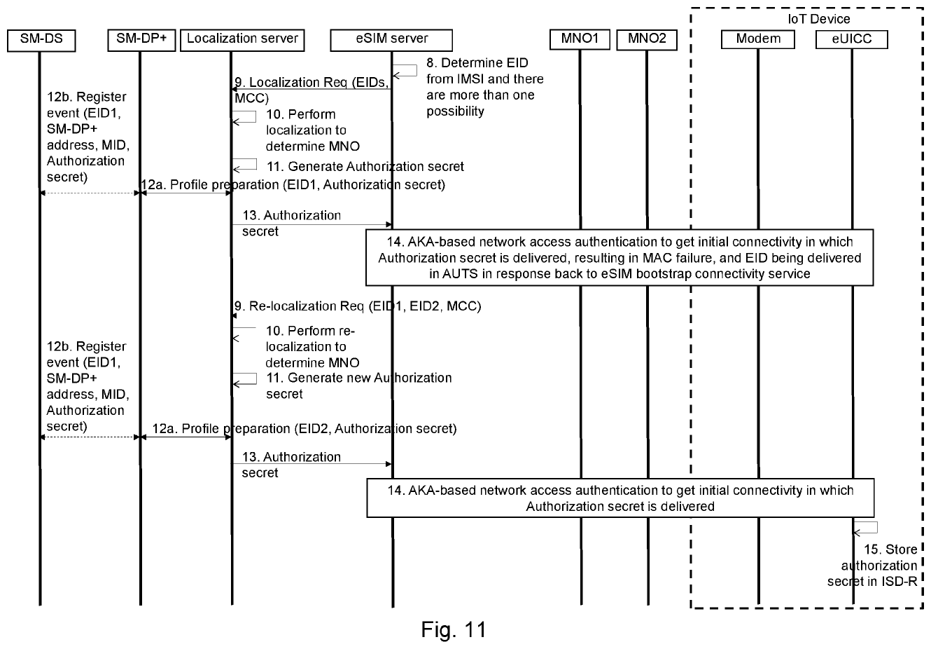

With reference next to the sequence diagram of FIG. 10, an example will be described where the IMSI is selected randomly according to the provisioning subscription profile and the EID is transferred to the eSIM server via the AKA protocol. Step 8 in FIG. 8 for this particular case is detailed in FIG. 10.

Step 8a: The HSS of the eSIM server generates a random value RAND for use in the AKA protocol.

Step 8b: The eSIM server uses the RAND and a global secret shared with the provisioning subscription profile to derive encryption key K_enc. In addition, temporary values for Ki (a subscriber key) and OPc (a key derived with Ki and an Operator Code as input) denoted Ki_tmp and OPc_tmp are derived (using same key derivation) for use in the network access authentication.

Step 8c: The Authentication Token (AUTN), expected response (XRES), Cipher key (CK), and Integrity key (IK) values are computed according to ordinary network access authentication algorithms using RAND, Ki_tmp, and OPc_tmp as input.

Step 8d: The authentication vector (RAND, AUTN, XRES, CK, IK) is delivered from the eSIM server to the visiting mobile network (MNO1).

Step 8e: The visiting network sends RAND and AUTN as an authentication challenge to the modem of the IoT device.

Step 8f: The modem invokes the Authenticate command of the eUICC where RAND and AUTN are provided.

Step 8g: The provisioning subscription profile derives K_enc, Ki_tmp, and OPc_tmp using RAND and the shared secret.

Step 8h: The provisioning subscription profile verifies AUTN using RAND, Ki_tmp, and OPc_tmp.

Step 8i: Upon successful verification, the EID is encrypted using K_enc and the encrypted data is formatted into an AUTS message.

Step 8j: The provisioning subscription profile enables the eUICC to signal a synchronization error and provides AUTS as a response to the request in step 8f.

Step 8k: The modem responds with synchronization error to the visiting network and provides the AUTS.

Step 8l: The visiting network responds with synchronization error to the eSIM server and provides the AUTS.

Step 8m: The eSIM server decrypts the encrypted part of AUTS with K_enc derived in step 8b to obtain the EID.

In other words, the AUTS is here used to transfer/obtain the EID, and not to indicate a true synchronization error, even if Step 8j mentions above that a synchronization error is signalled.

The EID might be represented by 32 digits. To encode EID one possibility is then to group 3 digits together and encode them as a number between 0-999 represented by 10 bits. The 32-digit EID can then be represented by 110 digits, but since the 2 last digits of EID are check digits 30-digits (100 bits) is sufficient. The size of the AUTS parameter might be 112 bits. The encryption may for example be performed as follows using the AES encryption algorithm: the encrypted data is obtained by first encrypting a string (e.g., “AUTS” for EID) using K_enc, truncate the result to the size of the data to be encrypted, and then perform an XOR operation between the truncated result and the data to be encrypted. In pseudo-code this can be expressed as follows, where the final size is 100 bits:

$$E ( EID ) = EID XOR E ( “ AUTS ” ) \_trune$$

As an example, the full 112-bit AUTS can be the encrypted EID of 100 bits followed by 12 random bits.

The shared secret used to derive K_enc may be a static global secret between the provisioning subscription profile and the eSIM server. Even though RAND is used in the derivation of K_enc such that they become session specific, it might be desirable to use session specific keys also to derive the shared secret. In case of 5G cellular connectivity and the use of a SUCI, the eSIM server private-public key pair and the ephemeral key pair generated by the eUICC for SUCI protection might be used in establishing a ECDH shared secret from which K_enc may be derived.

Aspects of IMSI collision will be disclosed next. The MAC verification in step 14i of FIG. 9 may fail due to different reasons. One reason is that, in the case the EID is encoded into the IMSI, there is a collision of IMSIs, although this should occur very rarely. With IMSI collision is meant that there is at least one more EID in the eSIM server database that has the same IMSI as determined for the eUICC in step 8 in FIG. 8 and the eSIM server HSS selected the wrong entry in the database (i.e., the wrong EID). This results in an erroneous shared secret being derived and MAC verification failure. The provisioning subscription profile then needs to send its EID to the eSIM server. Another reason for MAC failure is that the AUTN value was somehow modified during transfer. The provisioning server cannot distinguish between these two cases and the EID will therefore always be provided in case of MAC failure.

The eSIM server will know when there is an IMSI collision and there is a risk that the wrong EID is selected. In case of IMSI collision there are more than one entry of the eSIM server database matching the IMSI in step 8 in FIG. 8. The localization procedure may help in select the correct EID (i.e., the correct entry). The localization rules may be such that a given EID range belongs to IoT devices from a certain enterprise for which a certain set of countries are valid for where the IoT device might be deployed based on pre-negotiated MNO contracts. As an example, assume that an IoT device connects via a visiting network in a certain country and there are two possible EIDs deduced from the IMSI. However, according to the localization rules only one of the EIDs is in an EID range from an enterprise where localization is possible to an MNO in the particular country in question, which means this EID shall be selected.

Depending on the relation between eSIM server and localization server the localization may be leveraged in the choice of EID. Reference is next made to the sequence diagram of FIG. 10 where a collision occurs.

Step 8: There are more than one entry (i.e., more than one EID) in the database matching to the received IMSI.

Step 9: The whole list of possible EIDs is provided to the localization server in a localization request.

Step 10: The localization server performs localization to determine the MNO.

Step 11: The localization server selects a suitable EID from the list for which an authorization secret is generated.

Steps 12a, 12b: An operational subscription profile is prepared for download for the selected EID (denoted EID1).

Step 13: The authorization secret is provided from the localization server to the eSIM server.

Step 14: The eSIM server executes the AKA protocol (according to steps 14a-14h in FIG. 8) in which the authorization secret is transferred to the provisioning subscription profile. A MAC failure occurs (as in step 14i in FIG. 9) and the EID is returned (in encrypted form) to the eSIM server in the AUTS formatted message (where steps corresponding to steps 8i-8m of FIG. 9 are performed). A re-localization is requested from the localization server. Steps 9-13 are repeated with the new EID (called EID2) received from the eUICC and a new authorization secret is generated and returned to the eSIM server. The authorization secret is then delivered to the provisioning subscription profile and stored in ISD-R according to step 14 (as detailed in FIG. 8) and step 15. A new authentication vector with a new RAND is generated.

The use of a SIM OTA procedure to securely transfer information to the eUICC allows to provide more information than when using the AKA protocol. For example, in the examples disclosed with references to FIG. 5 and FIG. 6, the eUICC may not need to be equipped with default SM-DP+ address. The address to the SM-DP+ (or to the SM-DS if that option is used) may be provided to the eUICC using a SIM OTA procedure along with the authorization secret.

The SM-DP+/SM-DS OID is typically small enough in size to be provided using the AKA protocol. For example, the SM-DS OID may be securely provided using the AKA protocol to an eUICC. As long as the SM-DS address is configured for use by IPA, for example configured in the IoT device during device production, secure subscription profile download can be performed where the eUICC uses SM-DS information in the eUICC to verify information obtained from the SM-DS during the operational subscription profile download. Similarly, the SM-DP+ OID in combination with for example ICCID can be provided over the AKA protocol to the eUICC. As long as the SM-DP+ address is configured for use by the IPA secure operational subscription profile download can be performed by verifying information obtained from the SM-DP+ during the profile download.

As already mentioned above, a SIM OTA procedure is less constrained in the size of the information that can be transferred from the eSIM server to the eUICC compared to using the AKA protocol. On the other hand, a SIM OTA procedure relies on the use of Short Message Service (SMS) messages or HTTPS as the bearer of the information, which implies that a SIM OTA procedure might be unsuitable for low-power IoT devices connecting over LPWA networks, such as narrowband (NB) IoT networks. Using the AKA protocol for the transfer of information is possible for all IoT devices supporting the needed protocols. Further, the Constrained Application Protocol (CoAP) over Datagram Transport Layer Security (DTLS) over User Datagram Protocol (UDP) in addition to HTTPS over the Transmission Control Protocol (TCP) can be used in order to address low-power IoT devices allowing the SIM OTA procedure to be used also for low-power IoT devices.

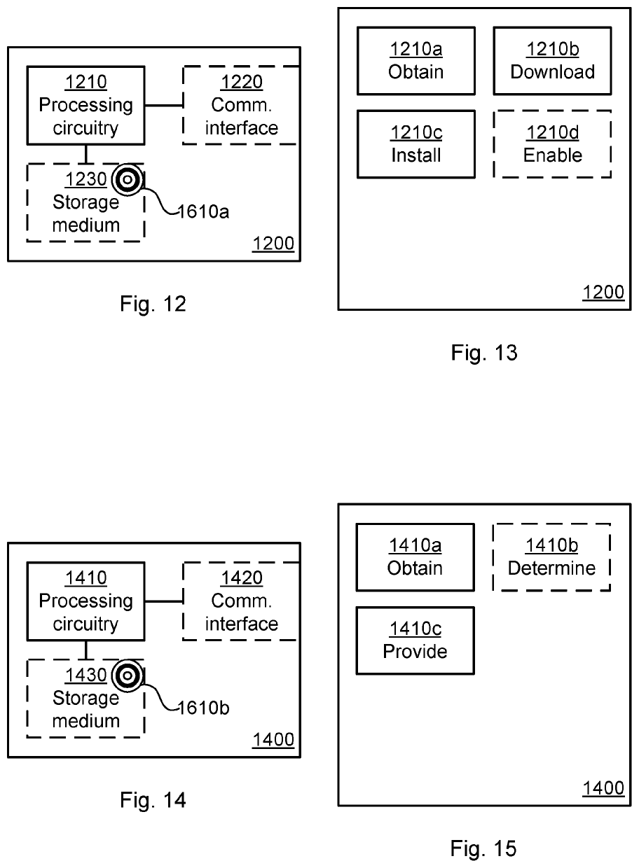

FIG. 12 schematically illustrates, in terms of a number of functional units, the components of a subscriber module 1200 according to an embodiment. Processing circuitry 1210 is provided using any combination of one or more of a suitable central processing unit (CPU), multiprocessor, microcontroller, digital signal processor (DSP), etc., capable of executing software instructions stored in a computer program product 1610a (as in FIG. 16), e.g., in the form of a storage medium 1230. The processing circuitry 1210 may further be provided as at least one application specific integrated circuit (ASIC), or field programmable gate array (FPGA).

Particularly, the processing circuitry 1210 is configured to cause the subscriber module 1200 to perform a set of operations, or steps, as disclosed above. For example, the storage medium 1230 may store the set of operations, and the processing circuitry 1210 may be configured to retrieve the set of operations from the storage medium 1230 to cause the subscriber module 1200 to perform the set of operations. The set of operations may be provided as a set of executable instructions. Thus the processing circuitry 1210 is thereby arranged to execute methods as herein disclosed.

The storage medium 1230 may also comprise persistent storage, which, for example, can be any single one or combination of magnetic memory, optical memory, solid state memory or even remotely mounted memory.

The subscriber module 1200 may further comprise a communications interface 1220 for communications with other entities, functions, nodes, and devices, as in FIG. 1. As such the communications interface 1220 may comprise one or more transmitters and receivers, comprising analogue and digital components.

The processing circuitry 1210 controls the general operation of the subscriber module 1200 e.g., by sending data and control signals to the communications interface 1220 and the storage medium 1230, by receiving data and reports from the communications interface 1220, and by retrieving data and instructions from the storage medium 1230. Other components, as well as the related functionality, of the subscriber module 1200 are omitted in order not to obscure the concepts presented herein.

FIG. 13 schematically illustrates, in terms of a number of functional modules, the components of a subscriber module 1200 according to an embodiment. The subscriber module 1200 of FIG. 13 comprises a number of functional modules; an obtain module 1210a configured to perform step S102, a download module 1210b configured to perform step S104, and an install module 1210c configured to perform step S106. The subscriber module 1200 of FIG. 13 may further comprise a number of optional functional modules, such as an enable module 1210d configured to perform step S108. In general terms, each functional module 1210a: 1210d may be implemented in hardware or in software. Preferably, one or more or all functional modules 1210a: 1210d may be implemented by the processing circuitry 1210, possibly in cooperation with the communications interface 1220 and/or the storage medium 1230. The processing circuitry 1210 may thus be arranged to from the storage medium 1230 fetch instructions as provided by a functional module 1210a: 1210d and to execute these instructions, thereby performing any steps of the subscriber module 1200 as disclosed herein.

FIG. 14 schematically illustrates, in terms of a number of functional units, the components of an eSIM server 1400 according to an embodiment. Processing circuitry 1410 is provided using any combination of one or more of a suitable central processing unit (CPU), multiprocessor, microcontroller, digital signal processor (DSP), etc., capable of executing software instructions stored in a computer program product 1610b (as in FIG. 16), e.g., in the form of a storage medium 1430. The processing circuitry 1410 may further be provided as at least one application specific integrated circuit (ASIC), or field programmable gate array (FPGA).

Particularly, the processing circuitry 1410 is configured to cause the eSIM server 1400 to perform a set of operations, or steps, as disclosed above. For example, the storage medium 1430 may store the set of operations, and the processing circuitry 1410 may be configured to retrieve the set of operations from the storage medium 1430 to cause the eSIM server 1400 to perform the set of operations. The set of operations may be provided as a set of executable instructions. Thus the processing circuitry 1410 is thereby arranged to execute methods as herein disclosed.

The storage medium 1430 may also comprise persistent storage, which, for example, can be any single one or combination of magnetic memory, optical memory, solid state memory or even remotely mounted memory.

The eSIM server 1400 may further comprise a communications interface 1420 for communications with other entities, functions, nodes, and devices, as in FIG. 1. As such the communications interface 1420 may comprise one or more transmitters and receivers, comprising analogue and digital components.

The processing circuitry 1410 controls the general operation of the eSIM server 1400 e.g., by sending data and control signals to the communications interface 1420 and the storage medium 1430, by receiving data and reports from the communications interface 1420, and by retrieving data and instructions from the storage medium 1430. Other components, as well as the related functionality, of the eSIM server 1400 are omitted in order not to obscure the concepts presented herein.

FIG. 15 schematically illustrates, in terms of a number of functional modules, the components of an eSIM server 1400 according to an embodiment. The eSIM server 1400 of FIG. 15 comprises a number of functional modules; an obtain module 1410a configured to perform step S202, and a provide module 1410c configured to perform step S206. The eSIM server 1400 of FIG. 15 may further comprise a number of optional functional modules, such as a determine module 1410b configured to perform step S204. In general terms, each functional module 1410a: 1410c may be implemented in hardware or in software. Preferably, one or more or all functional modules 1410a: 1410c may be implemented by the processing circuitry 1410, possibly in cooperation with the communications interface 1420 and/or the storage medium 1430. The processing circuitry 1410 may thus be arranged to from the storage medium 1430 fetch instructions as provided by a functional module 1410a: 1410c and to execute these instructions, thereby performing any steps of the eSIM server 1400 as disclosed herein.

FIG. 16 shows one example of a computer program product 1610a, 1610b comprising computer readable means 1630. On this computer readable means 1630, a computer program 1620a can be stored, which computer program 1620a can cause the processing circuitry 1210 and thereto operatively coupled entities and devices, such as the communications interface 1220 and the storage medium 1230, to execute methods according to embodiments described herein. The computer program 1620a and/or computer program product 1610a may thus provide means for performing any steps of the subscriber module 1200 as herein disclosed. On this computer readable means 1630, a computer program 1620b can be stored, which computer program 1620b can cause the processing circuitry 1410 and thereto operatively coupled entities and devices, such as the communications interface 1420 and the storage medium 1430, to execute methods according to embodiments described herein. The computer program 1620b and/or computer program product 1610b may thus provide means for performing any steps of the eSIM server 1400 as herein disclosed.

In the example of FIG. 16, the computer program product 1610a, 1610b is illustrated as an optical disc, such as a CD (compact disc) or a DVD (digital versatile disc) or a Blu-Ray disc. The computer program product 1610a, 1610b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1620a, 1620b is here schematically shown as a track on the depicted optical disk, the computer program 1620a, 1620b can be stored in any way which is suitable for the computer program product 1610a, 1610b.

The inventive concept has mainly been described above with reference to a few embodiments. However, as is readily appreciated by a person skilled in the art, other embodiments than the ones disclosed above are equally possible within the scope of the inventive concept, as defined by the claims.

1. A method for operational subscription profile download and installation, the method being performed by a subscriber module, the subscriber module being provided in a communication device, the subscriber module being provided with subscription data for use in establishing initial cellular connectivity, the method comprising:
obtaining download information for the operational subscription profile from an eSIM server and over an initial cellular connectivity connection for the communication device, wherein the download information is used by the subscriber module when determining that subscription profile download is authorized for the subscriber module, and wherein during cellular network access authentication to establish the initial cellular connectivity connection the subscriber module authenticates the eSIM server using the subscription data;
downloading the operational subscription profile from an enhanced Subscription Manager Data Preparation (SM-DP+) entity and in accordance with the download information, wherein the operational subscription profile is downloaded over the initial cellular connectivity connection for the communication device; and
installing the operational subscription profile in the subscriber module.

2. The method of claim 1, wherein the method further comprises:
enabling the operational subscription profile in the subscriber module upon having installed the operational subscription profile.

3. The method of claim 1, wherein the authentication of the eSIM server is performed using a secret shared with the eSIM server contained in, or derivable from, the subscription data.

4. The method of claim 3, wherein the subscription data is contained in a provisioning subscription profile installed in the subscriber module.

5. The method of claim 3, wherein the subscription data is contained as part of the subscriber module operating system, and wherein the subscriber module when no subscription profile is installed in the subscriber module uses the subscription data to act towards the communication device as a provisioning profile being present.

6. The method of claim 1, wherein a secret shared with the eSIM server for securing transfer of the download information from the eSIM server to the subscriber module over the initial cellular connectivity connection for the communication device is contained in, or derivable from, the subscription data.

7. The method of claim 3, wherein the secret shared with the eSIM server is derivable from the subscription data based on a private key of a private-public key pair of the subscriber module and a public key of a private-public key pair of the eSIM server, wherein the public key of the private-public key pair of the eSIM server is part of the subscription data.

8. The method of claim 1, wherein the download information is securely transferred from the eSIM server to the subscriber module using a SIM OTA procedure.

9. The method of claim 1, wherein the download information specifies an authorization secret used by the subscriber module to determine that the download of the operational subscription profile from the SM-DP+ entity is authorized for the subscriber module, and/or to determine that the download of SM-DP+ information from a Subscription Manager Discovery Service (SM-DS) entity specifying the SM-DP+ entity from which the operational subscription profile is to be downloaded is authorized, and wherein determining that the download is authorized is based on the subscriber module obtaining proof of the SM-DP+/SM-DS knowledge of the authorization secret as obtained during profile download preparation for the operational subscription profile.

10. The method of claim 1, wherein the download information identifies an object identifier (OID) of the SM-DP+ entity and/or an SM-DS entity, for the subscriber module to use when downloading and installing the operational subscription profile.

11. The method of claim 10, wherein the SM-DP+ entity from which the operational subscription profile is downloaded is either given by the OID identified by the download information when the OID is of the SM-DP+ entity, or is given by an event record received by the subscriber module from the SM-DS entity when the OID identified by the download information is of the SM-DS entity and wherein the SM-DS entity is given by the OID identified by the download information.

12. The method of claim 1, wherein the download information is obtained as part of performing network access authentication, using an AKA protocol, when establishing the initial cellular connectivity connection.

13. A method for enabling operational subscription profile download and installation to a subscriber module, the method being performed by an eSIM server, the method comprising:
obtaining a trigger for the operational subscription profile to be downloaded to the subscriber module;
providing, towards the subscriber module and over an initial cellular connectivity connection for a communication device in which the subscriber module is provided, download information for the operational subscription profile, wherein the download information is specified for the subscriber module to determine that subscription profile download is authorized for the subscriber module, and wherein during cellular network access authentication to establish the initial cellular connectivity connection the eSIM server provides authentication data towards the subscriber module for the subscriber module to authenticate the eSIM server.

14. The method of claim 13, wherein the method further comprises:
determining the download information during profile download preparation for the operational subscription profile.

15. The method of claim 13, wherein the authentication data provided by the eSIM server towards the subscriber module is derived using a secret shared with the subscriber module.

16. The method of claim 13, wherein transfer of the download information from the eSIM server to the subscriber module over the initial cellular connectivity connection for the communication device is secured using a secret shared with the subscriber module.

17. The method of claim 15, wherein the secret shared with the subscriber module is based on a public key of a private-public key pair of the subscriber module and a private key of a private-public key pair of the eSIM server.

18. (canceled)

19. The method of claim 13, wherein the download information specifies an authorization secret for use by the subscriber module to verify that the download of the operational subscription profile from an enhanced Subscription Manager Data Preparation (SM-DP+) entity is authorized for the subscriber module, and/or to verify that SM-DP+ information obtained by the subscriber module from a Subscription Manager Discovery Service (SM-DS) entity specifying the SM-DP+ entity from which the operational subscription profile is to be downloaded is authorized, and wherein the verification is based on the SM-DP+ entity and/or the SM-DS entity proving to the subscriber module knowledge of the authorization secret as obtained during profile download preparation for the operational subscription profile.

20. The method of claim 13, wherein the download information identifies an object identifier, OID, of an SM-DP+ entity and/or an SM-DS entity, for the subscriber module to use when downloading and installing the operational subscription profile.

21-23. (canceled)

24. A subscriber module for operational subscription profile download and installation, the subscriber module being provided in a communication device, the subscriber module being provided with subscription data for use in establishing initial cellular connectivity, the subscriber module comprising:
processing circuitry, the processing circuitry being configured to cause the subscriber module to:
obtain download information for the operational subscription profile from an eSIM server and over an initial cellular connectivity connection for the communication device, wherein the download information is used by the subscriber module when determining that subscription profile download is authorized for the subscriber module, and wherein during cellular network access authentication to establish the initial cellular connectivity connection the subscriber module authenticates the eSIM server using the subscription data;
download the operational subscription profile from an enhanced Subscription Manager Data Preparation, SM-DP+, entity and in accordance with the download information, wherein the operational subscription profile is downloaded over the initial cellular connectivity connection for the communication device; and
install the operational subscription profile in the subscriber module.

25-34. (canceled)
